(19) United States
(12) Patent Application Publication
(10) Pub. No.: US 2013/0097799 A1
(43) Pub. Date: Apr. 25, 2013

(54) WINDSCREEN WIPER DEVICE

(71) Applicant: Thomas Friscioni, Aumetz (FR)

(72) Inventor: Thomas Friscioni, Aumetz (FR)

(73) Assignee: FEDERAL-MOGUL S.A., Aubange (BE)

(21) Appl. No.: 13/642,718

(22) PCT Filed: Apr. 22, 2010
(86) PCT No.: PCT/EP2010/055389

§ 371 Date: Jan. 7, 2013

(51) Int. Cl. B60S 1/40

(52) U.S. Cl. CPC B60S 1/40
USPC 15/250.32

(57) ABSTRACT

A windscreen wiper device, particularly for automobiles, comprising an elastic, elongated carrier element, as well as an elongated wiper blade of a flexible material, which can be placed in abutment with a windscreen to be wiped, which wiper blade is of the flat blade type and includes at least one groove, in which groove a longitudinal strip of the carrier element is disposed, wherein said windscreen wiper device further comprises a mounting head for transferring a reciprocal movement to said wiper blade, wherein said windscreen wiper device further comprises a connecting device for detachably connecting said wiper blade directly to said mounting head, wherein said connecting device is positioned near one end of said wiper blade, with the special feature that said connecting device is provided with a spacer for maintaining a predetermined distance between said connecting device and said windscreen to be wiped.

### BACKGROUND OF THE INVENTION

1. Technical Field

The invention relates to a windscreen wiper device, particularly for automobiles, comprising an elastic, elongated carrier element, as well as an elongated wiper blade of a flexible material, which can be placed in abutment with a windscreen to be wiped, which wiper blade is of the flat blade type and includes at least one groove, in which groove a longitudinal strip of the carrier element is disposed, wherein the windscreen wiper device further comprises a mounting head for transferring a reciprocal movement to the wiper blade.

It is noted that the present invention is not restricted to cars, but also refers to rail coaches and other (fast) vehicles.

2. Related Art

Such a windscreen wiper device is known from European patent publication no. 1 514 752 (Federal-Mogul S.A.). The windscreen wiper device described in this European patent publication comprises a mounting head mountable on a drive shaft and an arm member pivotally connected to the mounting head by means of a pivot pin, wherein the arm member has a substantially U-shaped cross-section near the pivot pin comprising two side walls, wherein a part of the mounting head extends between the side walls and beyond the pivot pin.

A disadvantage of the windscreen wiper arm known from the above European patent publication is that it comprises many complex parts with a dedicated shape, wherein reference is made to the oscillating arm described therein consisting of a plastic arm member at one end thereof pivotally connected to a mounting head by means of a pivot pin and at the other end thereof folded around a rod-like part. Obviously, this needs complex machinery, tools, with all the expenses involved.

To obviate this disadvantage, in the sense that at minimum costs—without using complex machinery and additional tools—the present Applicant has already proposed in European patent application no. 08160187.4 a connecting device for detachably connecting the wiper blade directly to the mounting head, wherein the connecting device is positioned near one end of the wiper blade. The gist of the above proposal is to refrain from the use of an intermediate oscillating arm, thereby avoiding an articulation between the oscillating arm and the wiper blade, as well as between the mounting head and the oscillating ann. Further, by directly connecting the connecting device to the mounting head, the wiper blade is mounted closer to the windscreen to be wiped, so that the wiping properties are improved. Accordingly, a simple though effective windscreen wiper device is achieved which fits on all kinds of different cars.

However, by directly connecting the connecting device to the mounting head, it has become apparent that the wiping properties may deteriorate if the mounting head is not properly mounted on the shaft.

### SUMMARY OF THE INVENTION

It is an object of the present invention to obviate this disadvantage, i.e. to provide an improved windscreen wiper device, wherein excellent wiping properties are guaranteed at all times.

Thereto, according to the invention a windshield wiper arm mentioned in the preamble is characterized in that the connecting device is provided with a spacer for maintaining a predetermined distance between the connecting device and the windscreen to be wiped. Particularly, the spacer extends in downward direction from a bottom of the connecting device to the windscreen to be wiped, and wherein the spacer can be placed in abutment with the windscreen to be wiped. Hence, as a result of the use of the spacer or distance means, it is possible to mount the mounting head onto the shaft in a controllable manner, wherein the mounting head is firmly attached thereto, while being kept at a well-defined and predetermined distance from the windscreen to be wiped. In fact, by using different types of spacers for different cars, it is even possible to select such a distance for each type of car.

the spacer is preferably detachably connected to the connecting device, particularly through a snapping operation. In the alternative, the connecting device and the spacer are in one piece, such as one piece of plastic. In the latter case a unit consisting of the connecting device and the spacer preferably comprises a weakening to allow separation of the spacer from the connecting device, for example by hand or a specific tool. the weakening preferably consists of a weakening line to allow separation of the spacer from the connecting device through a torque action, for example by hand.

The connecting device and the mounting head are each preferably made of one piece. The present windscreen wiper device is particularly designed for use at a rear window of a car.

Preferably, the windscreen wiper device further comprises a connecting piece positioned near the other end of the wiper blade and connected to one end of the longitudinal strip.

Preferably, the wiper blade includes opposing longitudinal grooves on its longitudinal sides, in which grooves spaced-apart longitudinal strips of the carrier element are disposed, wherein neighboring ends of the longitudinal strips are interconnected by the connecting device at one end of the wiper blade and by the connecting piece at the other end of the wiper blade. the connecting device may be glued, soldered, clipped, snapped or welded onto the longitudinal strips.

In a preferred embodiment of a windscreen wiper device in accordance with the invention the mounting head is fixed for rotation to a shaft, and wherein the shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage, wherein the carriage can be translated alternately in a one linear direction and in another counter linear direction carrying the mounting head into translation. The present invention can therefore be used for circular or linear movement of the mounting head. Preferably, the shaft along a portion of its length and around at least a part of its outer surface is provided with a profile. the profile preferably includes longitudinal grooves extending in co-axial direction of the shaft. Hence, a fixation without any play (i.e. without axial movement and/or rotational movement) between the mounting head and the shaft is realized.

In a further preferred embodiment of a windscreen wiper device according to the invention the mounting head is clamped around the shaft. the mounting head particularly comprises a hole to receive the shaft, wherein the mounting head further comprises side walls extending beyond the shaft in mounted position thereof, and wherein the side walls are provided with a co-axial holes for receiving a pin for clamping the mounting head around the shaft through deformation of the side walls.

More in particular, the mounting head is clamped around the shaft through screwing a nut onto the pin. The mounting head as a whole is particularly made of a sheet material, such as sheet metal, to allow (elastic of plastic) deformation thereof during the clamping action.

In a further preferred embodiment of a windscreen wiper device in accordance with the invention the longitudinal strip is biassed in such a way that its curvature near the connecting device is larger than that its curvature near the other end of the wiper blade, all seen in dismounted position. In other words, in dismounted position the wiper blade has an asymmetric shape, seen along its middle transverse plane perpendicular to a windscreen to be wiped. Thus, the wiper blade is able to follow any curvature of a windscreen to be wiped, while the wiper blade is pressed onto the windscreen to be wiper with sufficient force to enhance the wiping properties.

In a further preferred embodiment of a windscreen wiper device according to the invention the interconnection between the mounting head and the wiper blade does not allow any pivotal movement. In other words, in mounted position the mounting head and the connecting device cannot move relative to one another, i.e. are stationary with respect to each other.

In a further preferred embodiment of a windscreen wiper device in accordance with the invention the connecting device comprises at least one resilient tongue engaging in a correspondingly shaped hole provided in the mounting head, and wherein the resilient tongue is movable between a outward position retaining the wiper blade onto the mounting head and an inward position releasing the wiper blade from the mounting head. In order to connect the wiper blade onto the mounting head, the resilient tongue is initially pushed in against a spring force—as if it were a push button—and then allowed to spring back into the hole provided in the mounting head, thus snapping, that is clipping the resilient tongue into the hole. By subsequently pushing in again the resilient tongue against the spring force, the wiper blade may be released from the mounting head. Particularly, the hole has a closed circumference. Preferably, the resilient tongue is hingeable along an hinge axis, wherein the hinge axis is orientated towards the mounting head (so that the resilient tongue opens away from the mounting head) or facing away from the mounting head near an outer edge of the joint part (so that the resilient tongue opens towards the mounting head). Particularly, the hinge axis is located at an outer edge of the connecting device.

In a further preferred embodiment of a windscreen wiper device according to the invention the mounting head has an at least substantially U-shaped cross-section at the location of its attachment to the connecting device, wherein each leg of the U-shaped cross-section comprises clamping members formed as inwardly bend edges at the end of the legs, which engage around longitudinal sides of the connecting device that face away from each other. Hence, a transverse locking of the connecting device inside the mounting head is achieved.

In a further preferred embodiment of a windscreen wiper device in accordance with the invention the hole is provided in a base of the U-shaped cross-section of the mounting head. In this embodiment the resilient tongue may be provided on an upper part of the connecting device. In addition thereto or instead thereof the connecting device may be provided with at least two lateral resilient tongues extending outwardly, wherein each tongue engages in a correspondingly shaped hole provided in each leg of the U-shaped cross-section of the mounting head. the holes preferably have a closed circumference. Such closed holes enhance the retention of the connection device onto the mounting head in all possible directions, particularly both horizontally and vertically.

Preferably, the mounting head has an at least substantially U-shaped cross-section at the location of its attachment to the connecting device, and wherein each leg of the U-shaped cross-section comprises clamping members formed as inwardly bend edges at the end of the legs, which engage around longitudinal sides of the connecting device that face away from each other. Accordingly, the interconnection thus achieved also ensures a blockage in vertical, that is transverse direction relative to the longitudinal direction of the wiper blade.

### THE DRAWINGS

The invention will now be explained in more detail with reference to figures illustrated in a drawing, wherein:

FIG. 1 is a perspective, schematic and exploded view of an embodiment of a windscreen wiper device in accordance with European patent application no. 08160187.4 mentioned earlier;

FIG. 2 shows a perspective, schematic view of a connecting device and a mounting head connected together, wherein a spacer according to the invention is used;

FIG. 3 schematically shows a perspective and a front view of the connecting device equipped with the spacer of FIG. 2;

FIG. 4 relates to a way for removing the spacer from the connecting device of FIGS. 2 and 3;

FIG. 5 shows various details of the mounting head and a driving shaft, as well as the way they are interconnected; and

FIG. 6 relates to the use of a nut to clamp the mounting head onto the shaft of FIG. 5.

### DETAILED DESCRIPTION

The windscreen wiper device 1 is built up of an elastomeric wiper blade 2, in the longitudinal sides of which opposing longitudinal grooves 3 are formed, and of longitudinal strips 4 made of spring band steel, which are fitted in the longitudinal grooves 3. the strips 4 form a flexible carrier element for the wiper blade 2, as it were, which is thus biassed in a curved position (the curvature in operative position being that of a windscreen to be wiped). Neighboring ends 5 of the strips 4 at one end of the wiper blade 2 are interconnected by means of a connecting piece 6 or “end cap” functioning as clamping member. In this embodiment, the connecting piece 6 is a separate constructional element, which may be form-locked (“positive locking” or “having a positive fit”) or force-locked to the ends 5 of the strips 4. In another preferred embodiment, the connecting piece 6 is in one piece with the strips 4 made of spring band steel. In the latter case the connecting piece 6 forms a transverse bridge for the strips 4, as it were.

The windscreen wiper device 1 is furthermore built up of a connecting device 7 of plastic material for a mounting head 8. Alternatively, the connecting device 7 may also be made of metal, such as steel or aluminum. The connecting device 7 may comprise clamping members that are integral therewith, which engage around longitudinal sides of the strips 4 that face away from each other, as a result of which the connecting device 7 is firmly attached to the unit consisting of the wiper blade 2 and the strips 4. As can be seen, the connecting device 7 is connected to the wiper blade 2 at its other end, that is opposite the connecting piece 6.

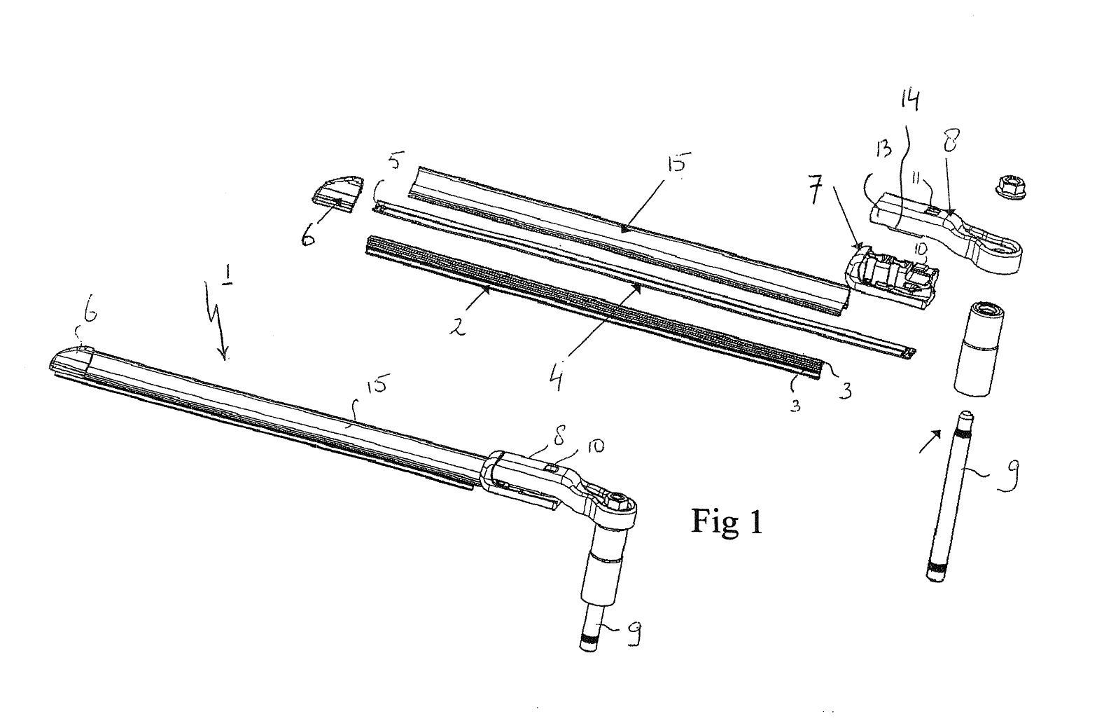

As illustrated in FIG. 1 the windscreen wiper device 1 according to the invention comprises a plastic or metallic mounting head 8 which can be fixed for rotation to a shaft 9 driven, via a mechanism not illustrated, by a small motor. In use, the shaft 9 rotates alternately in a clockwise and in a counter-clockwise sense carrying the mounting head 8 into rotation also, which in turn draws the connecting device 7 in rotation and thereby moves the wiper blade 2.

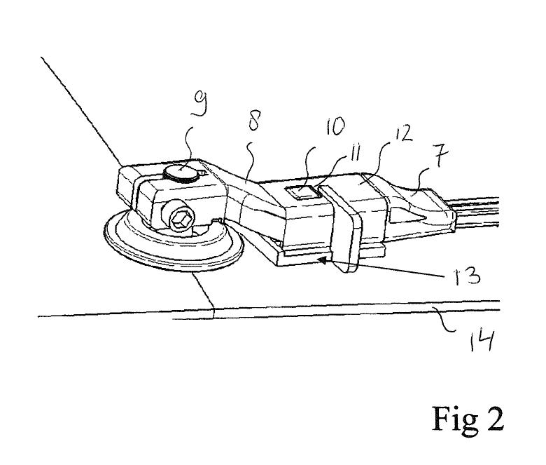

With reference to FIGS. 2, 3 and 4 the connecting device 7 comprises one resilient tongue 10 extending outwardly, while the mounting head 8 has an U-shaped cross-section at the location of its connection to the connecting device 7, so that the tongue 10 engages in an identically shaped hole 11 provided in a base 12 of the U-shaped cross-section. The connecting device 7 can be easily slid in horizontal direction on a free end of the mounting head 8. During this sliding movement the resilient tongue 10 is initially pushed in against a spring force and then allowed to spring back into the hole 11, thus snapping, that is clipping the resilient tongue 10 into the hole 11. This is a so-called bayonet-connection. The mounting head 8 together with the connecting device 7 are then ready for use. By subsequently pushing in again the resilient tongue 10 against the spring force (as if it were a push button), the connecting device 7 together with the wiper blade 2 (not shown) may be released from the mounting head 8. Dismounting the connecting device 7 with the wiper blade 2 (not shown) from the mounting head 8 is thus realized by sliding the connecting device 7 together with the wiper blade 2 (not shown) in a direction away from the mounting head 8.

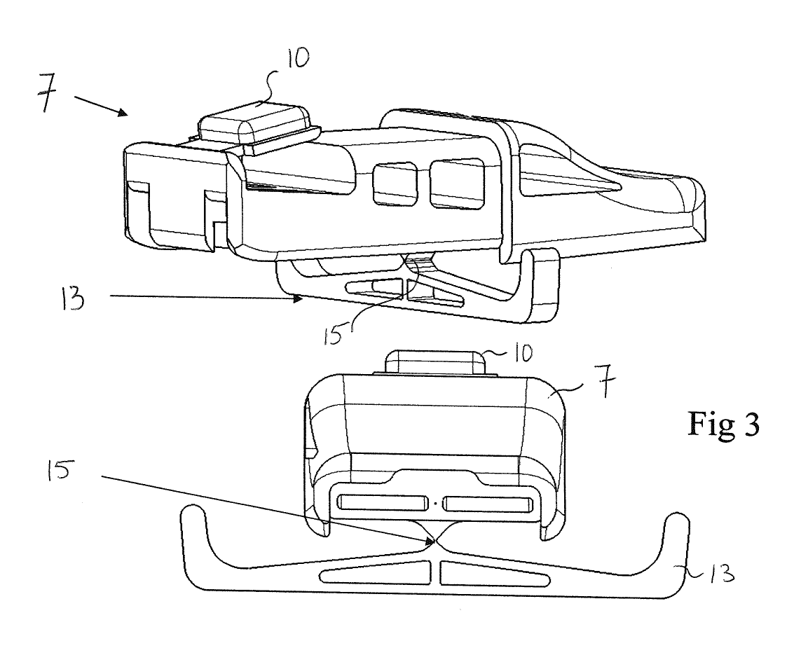

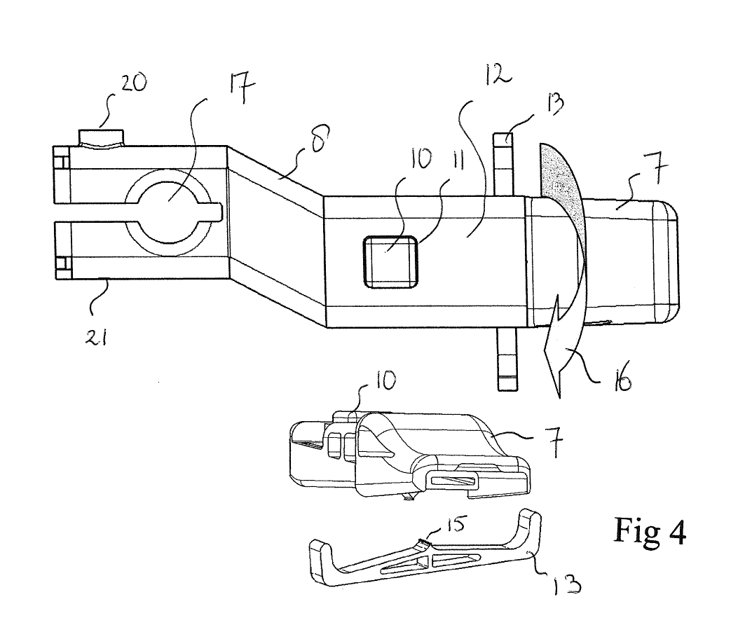

As shown in FIGS. 2 and 3, the connecting device 7 is equipped in one piece therewith with a W-shaped spacer of distance means 13. the spacer 13 ensures that the mounting head 8 is mounted onto the shaft in a well-defined and controllable manner, wherein the mounting head 8 is kept at a predetermined (constant) distance from a windscreen 14 to be wiped. As can be seen from FIG. 3, a plastic unit consisting of the connecting device 7 and the spacer 13 comprises a weakening line or tight junction 15 to allow separation of the spacer 13 from the connecting device 7 through a torque action in the direction of an arrow 16 shown in FIG. 4.

FIG. 4 schematically relates to a top view of the connecting device 7 and the mounting head 8 being connected together (with the spacer 13 still being present) and a perspective view of the connecting device 7 seen from the back (with the spacer 13 as a separate element being already removed from the connecting device 7).

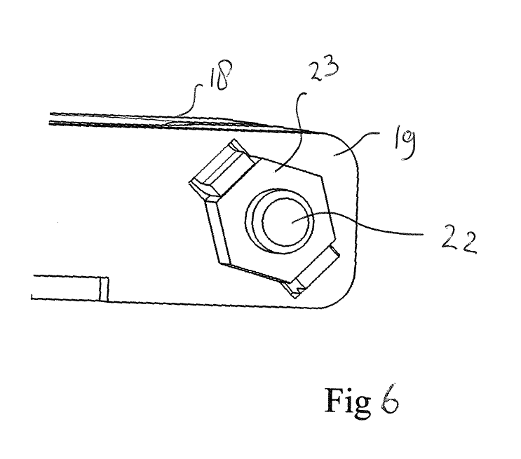

As can be seen from FIGS. 4, 5 and 6, the mounting head 8 comprises a hole 17 to receive the shaft 9, wherein the mounting head 8 further comprises side walls 18,19 extending beyond the hole 17 (and the shaft 9 in mounted position thereof). the side walls 18,19 are provided with a co-axial holes 20,21 for receiving a pin 22 having screw thread for clamping the mounting head 8 around the shaft 9 through elastic deformation of the side walls 18,19. the elastic deformation is finalized by screwing a nut 23 onto the pin (FIG. 6). The mounting head 8 as a whole is particularly made of a sheet material, such as sheet metal, to allow (elastic of plastic) deformation thereof during the clamping action. For esthetic reasons the interconnection between the mounting head 8 and the shaft 9 is covered by a cap 24.

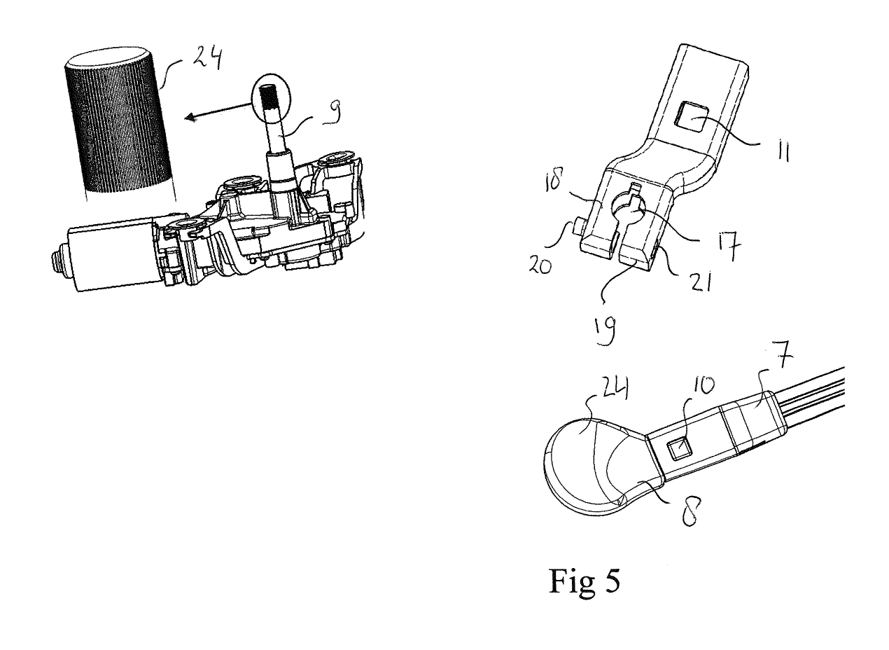

With reference to FIG. 5, the shaft 9 along a portion of its length and around its outer surface is provided with a profile. the profile, as shown, includes longitudinal grooves 24 extending in co-axial direction of the shaft 9. As a result, an improved fixation without any play (i.e. without axial movement and/or rotational movement) between the mounting head 8 and the shaft 9 is realized.

The invention is not restricted to the variants shown in the drawing, but it also extends to other embodiments that fall within the scope of the appended claims.

1. A windscreen wiper device comprising an elastic, elongated carrier element, as well as an elongated wiper blade of a flexible material, which can be placed in abutment with a windscreen to be wiped, which wiper blade is of the flat blade type and includes at least one groove, in which groove a longitudinal strip of the carrier element is disposed, wherein said windscreen wiper device further comprises a mounting head for transferring a reciprocal movement to said wiper blade, wherein said windscreen wiper device further comprises a connecting device for detachably connecting said wiper blade directly to said mounting head, wherein said connecting device is positioned near one end of said wiper blade, and wherein said connecting device is provided with a spacer for maintaining a predetermined distance between said connecting device and the windscreen to be wiped.

2. The windscreen wiper device according to claim 1, wherein said spacer extends in downward direction from a bottom of said connecting device, and wherein said spacer can be placed in abutment with the windscreen to be wiped.

3. The windscreen wiper device according to claim 1, wherein said spacer is detachably connected to said connecting device.

4. The windscreen wiper device according to claim 3, wherein said spacer is detachably connected to said connecting device through a snapping operation.

5. The windscreen wiper device according to claim 1, wherein said connecting device and said spacer are in one piece.

6. The windscreen wiper device according to claim 5, wherein a unit consisting of said connecting device and said spacer comprises a weakening to allow separation of said spacer from said connecting device.

7. The windscreen wiper device according to claim 6, wherein a unit consisting of said connecting device and said spacer comprises a weakening line to allow separation of said spacer from said connecting device through a torque action.

8. The windscreen wiper device according to claim 1, wherein said mounting head is fixed for rotation to a shaft, and wherein said shaft is rotatable alternately in a clockwise and in a counter-clockwise sense carrying said mounting head into rotation.

9. The windscreen wiper device according to claim 8, wherein said shaft along a portion of its length and around at least a part of its outer surface is provided with a profile.

10. The windscreen wiper device according to claim 9, wherein said profile comprises longitudinal grooves extending in co-axial direction of said shaft.

11. The windscreen wiper device according to claim 8, wherein said mounting head is clamped around said shaft.

12. The windscreen wiper device according to claim 11, wherein said mounting head comprises a hole to receive said shaft, wherein said mounting head further comprises side walls extending beyond said shaft in mounted position thereof, and wherein said side walls are provided with a co-axial holes for receiving a pin for clamping said mounting head around said shaft through deformation of said side walls.

13. The windscreen wiper device according to claim 12, wherein said mounting head is clamped around said shaft through screwing a nut onto said pin.

14. The windscreen wiper device according to claim 1, wherein said windscreen wiper device further comprises a connecting piece positioned near the other end of said wiper blade and connected to one end of said longitudinal strip.

15. The windscreen wiper device according to claim 1, wherein said longitudinal strip is biassed in such a way that its curvature near the connecting device is larger than its curvature near the other end of said wiper blade.

16. windscreen wiper device according to claim 1, wherein the interconnection between the mounting head and the wiper blade does not allow any pivotal movement.

17. The windscreen wiper device according to claim 1, wherein said connecting device comprises at least one resilient tongue engaging in a correspondingly shaped hole provided in said mounting head, and wherein said resilient tongue is movable between a outward position retaining said wiper blade onto said mounting head and an inward position releasing said wiper blade from said mounting head.

18. The windscreen wiper device according to claim 17, wherein said mounting head has an at least substantially U-shaped cross-section at the location of its attachment to said connecting device, and wherein each leg of said U-shaped cross-section comprises clamping members formed as inwardly bend edges at the end of said legs, which engage around longitudinal sides of said connecting device that face away from each other.

19. The windscreen wiper device according to claim 18, wherein said hole is provided in a base of the U-shaped cross-section of said mounting head.

20. A wiper blade device comprising a wiper blade; a carrier element supporting the wiper blade; a connecting device on the carrier element for detachably connecting the wiper blade device to a reciprocally moveable mounting head of a vehicle; and a spacer projecting downwardly from said connecting device and engageable with to windscreen to be wiped to maintain a predetermined spacing of said connecting device from the windscreen.

21. The wiper blade device according to claim 20, wherein said spacer is connected by a frangible connection to said connecting device and is separable therefrom by application of a torque force sufficient to break the frangible connection.
